(19) United States
(12) Patent Application Publication
(10) Pub. No.: US 2026/0251559 A1
(43) Pub. Date: Aug. 27, 2026

(54) DISPERSION-BASED NONLOCAL POLARIZATION-SPECTRAL HIGH-DIMENSIONAL PHOTODETECTOR

(71) Applicant: CHANGCHUN INSTITUTE OF OPTICS, FINE MECHANICS AND PHYSICS, CHINESE ACADEMY OF SCIENCES, Changchun (CN)

(72) Inventors: Wei LI, Changchun (CN); Yandong FAN, Changchun (CN); Yang AN, Changchun (CN); Weian HUANG, Changchun (CN); Fei ZHU, Changchun (CN); Chengwei QIU, Changchun (CN)

(73) Assignee: CHANGCHUN INSTITUTE OF OPTICS, FINE MECHANICS AND PHYSICS, CHINESE ACADEMY OF SCIENCES, Changchun (CN)

(21) Appl. No.: 19/644,837

(22) Filed: Apr. 10, 2026

Related U.S. Application Data
(63) Continuation of application No. PCT/CN2024/073609, filed on Jan. 23, 2024.

(30) Foreign Application Priority Data
Oct. 10, 2023 (CN) 202311308027.2

(51) Int. Cl. G01N 21/31; G01N 21/21

(52) U.S. Cl. CPC G01N 21/31; G01N 21/21

(57) ABSTRACT

A dispersion-based non-local polarization and spectral high-dimensional photoelectric detector. Incident light is modulated by a spatial light modulation module and then irradiates a non-local dispersion device in the form of a specific spatial light field. Because of different polarization states and spectrums of the light in the spatial light field, the spatial light field that has passed through an angular channel generation component irradiating the non-local dispersion device will generate a corresponding transmitted intensity distribution; a light receiving module images the transmitted intensity distribution; an information analysis module analyzes the transmitted intensity distribution, and outputs high-dimensional intensity, polarization and spectral information of the incident light.

### CROSS-REFERENCE TO RELATED APPLICATIONS

The present application is a continuation of PCT International Application No. PCT/CN2024/073609 filed on Jan. 23, 2024, which claims priority to Chinese patent application No. 202311308027.2, entitled “DISPERSION-BASED NONLOCAL POLARIZATION-SPECTRAL HIGH-DIMENSIONAL PHOTODETECTOR”, filed on Oct. 10, 2023, the entire contents of each of which are incorporated herein by reference for all purposes. No new matter has been introduced.

### TECHNICAL FIELD

The present disclosure relates to the technical field of optical detection, and specifically provides a dispersion-based nonlocal polarization-spectral high-dimensional photodetector.

### BACKGROUND

The polarization-spectral multiplexing detection technology enables simultaneous detection of polarization-state information and spectral information of a target. It features high information density and multiple information dimensions, and can directly reflect the material composition, surface texture and chemical composition of the target, thereby achieving multi-dimensional information extraction and effective identification of the target. The polarization-spectral multiplexing detection technology is widely used in celestial detection, biological recognition, remote sensing, medical diagnosis and other fields.

However, traditional polarization-spectral multiplexing detection technology is generally implemented by combining multiple polarization detectors and spectrometers. The polarization detectors and spectrometers usually adopt the following two methods for information extraction and analysis: the first is the time-division method, which arranges responses corresponding to different polarization or spectral information in a time sequence and then performs extraction and analysis respectively; the second is the amplitude-division method, which uses polarization-selective elements such as metal wire grids or dispersion elements such as prisms to disperse different polarization or spectral information to different spatial positions, and then performs extraction and analysis respectively. However, such methods cannot achieve wide-spectrum polarization-spectral multiplexing detection while realizing the imaging function. In addition, the existing methods have two other problems: first, polarization and spectral information are extracted separately, so when performing multiplexing detection of full-Stokes polarization states and ultra-wide spectra, the number of required detection units or total detection time increases geometrically, making them unable to meet application requirements in the fields of miniaturization or rapid detection; second, such combined detection methods can only obtain intensity and polarization states at fixed wavelengths, or spectral and intensity information under a fixed polarization state. For practical applications where polarization and intensity vary with wavelength over a wide spectrum (such as light emitted by blazars or reflected light from thin-film systems under oblique incidence), truly accurate results cannot be obtained.

### SUMMARY

To solve the above-mentioned issues, the present disclosure provides a dispersion-based nonlocal polarization-spectral high-dimensional photodetector, which can realize detection and imaging of high-dimensional polarization-spectral information in a single measurement within a wide spectral range; the detector opens up a new path for the research of ultra-compact, high-dimensional photoelectric imaging detectors.

The present disclosure provides a dispersion-based nonlocal polarization-spectral high-dimensional photodetector, comprising a spatial light modulation device, a nonlocal dispersion device, an optical receiving device, and an information analysis device;
wherein an incident light is modulated by the spatial light modulation device to form a spatial light field, the polarization state and spectra of light in the spatial light field are different, the spatial light field irradiating the nonlocal dispersion device generates a corresponding transmission intensity distribution; the optical receiving module receives and images the transmission intensity distribution, and the information analysis module analyzes the transmission intensity distribution and outputs high-dimensional intensity, polarization, and spectral information of the incident light.

Preferably, the spatial light modulation device comprises a beam collimation assembly, a polarization beam-splitting assembly, and a beam converging assembly; wherein the beam collimation assembly is configured to collimate the incident light; the polarization beam-splitting assembly is configured to change the polarization state of the incident light; and the beam converging assembly is configured to converge the incident light.

Preferably, the nonlocal dispersion device can adopt interface, single-layer thin-film structure, multi-layer thin-film structure, metasurface, photonic crystal, two-dimensional material heterojunction device, or porous scattering medium.

Preferably, the intensity Iₜ(ψ, λ, θ, φ, η) at any point in the transmission intensity distribution generated by the nonlocal dispersion device satisfies following formula:

Iₜ(ψ,λ,θ,φ,η)=A²·(Tₚ(θ,λ)·B(P,φ,η)+Tₛ(θ,λ)·C(P,φ,η))
wherein A denotes the amplitude of the spatial light field; Tₚ (θ, λ) denotes the transmittance spectrum of the nonlocal dispersion device for p-polarized light at an incident angle θ;
Tₛ(θ, λ) denotes a transmittance spectrum of the nonlocal dispersion device for s-polarized light at an incident angle θ;
P(ψ,δ) denotes a polarization state of light with an electric field Eᵢ=A[cos ψ sin ψe^{iδ}]^{T}, wherein ψ denotes the amplitude angle of polarized light, δ denotes a phase difference between electric fields in x direction and y direction, φ denotes an azimuth angle at any point in the transmission intensity distribution, and η denotes a phase retardation between p component and s component in the nonlocal dispersion device;
B(P,φ,η) and C(P,φ,η) are both constant coefficients.

Preferably, the nonlocal dispersion device consists of eight layers of transparent thin films, which are sequentially: titanium dioxide film, silicon dioxide film, titanium dioxide film, single-crystal quartz film, magnesium fluoride crystal film, titanium dioxide film, silicon dioxide film, and titanium dioxide film.

Preferably, the optical receiving device adopts an optical camera for receiving the transmission intensity distribution.

Preferably, the information analysis device analyzes the transmission intensity distribution via the residual neural network.

Compared with the prior art, the present disclosure can achieve the following beneficial effects.

The present disclosure enables high-precision detection of high-dimensional information of light whose polarization state varies with wavelength, accurate intensity, polarization and spectral information can be obtained through a single measurement by a single detector, which greatly reduces the complexity and measurement time cost of existing polarization-spectral imaging systems, and is of great significance for the miniaturization and lightweight development of polarization-spectral imaging systems.

The application wavelength range of the present disclosure is not limited by materials; by selecting appropriate materials to design the nonlocal dispersion device, detection and imaging of high-dimensional polarization-spectral information in any desired wavelength range can be realized without combination with a spectrometer.

### BRIEF DESCRIPTION OF DRAWINGS

FIG. 1 is a schematic diagram of a composition of a dispersion-based nonlocal polarization-spectral high-dimensional photodetector according to an embodiment of the present disclosure.

FIG. 2 is a schematic structural diagram of a nonlocal dispersion device operating in the 400-900 nm wide wavelength range according to an embodiment of the present disclosure.

FIG. 3 is a result diagram of a transmission intensity distribution obtained in k-space using the 400-900 nm wide-wavelength range nonlocal dispersion device according to an embodiment of the present disclosure.

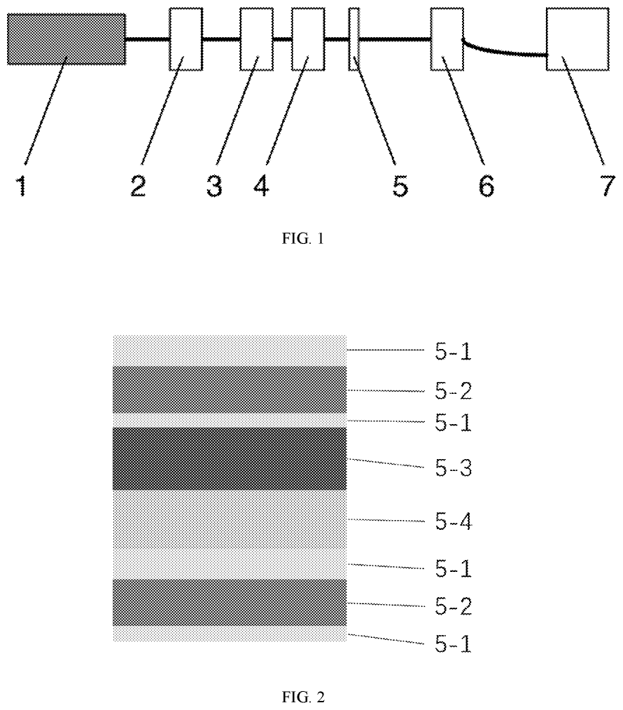

### REFERENCE SIGNS

incident light 1, beam collimation assembly 2, polarization beam-splitting assembly 3, beam converging assembly 4, nonlocal dispersion device 5, titanium dioxide film 5-1, silicon dioxide film 5-2, single-crystal quartz film 5-3, magnesium fluoride crystal film 5-4, optical receiving device 6, information analysis device 7.

### DETAILED DESCRIPTION

Hereinafter, embodiments of the present disclosure will be described with reference to the drawings. In the following description, the same modules are denoted by the same reference signs. When reference signs are the same, their names and functions are also the same. Therefore, their detailed descriptions will not be repeated.

To make the objectives, technical solutions, and advantages of the present disclosure clearer, the present disclosure will be further described in detail below with reference to the drawings and specific embodiments. It should be understood that the specific embodiments described herein are only for explaining the present disclosure and do not constitute a limitation on the present disclosure.

The dispersion-based nonlocal polarization-spectral high-dimensional photodetector provided by an embodiment of the present disclosure mainly comprises a spatial light modulation device, a nonlocal dispersion device 5, an optical receiving device 6 and an information analysis device 7. The detection and imaging of high dimensional polarization spectral information of incident light 1 can be realized in a single measurement. The incident light 1 may be incoming signal light or a spontaneous light source, usually including all types of light sources with low power density such as continuous wave lasers and halogen lamps etc., or signal light to be measured.

The spatial light modulation device is mainly used for shaping the incident light 1 and adjusting its polarization state, to finally obtain the required spatial light field. After entering the spatial light modulation device, the incident light 1 sequentially passes through a beam collimation assembly 2, a polarization beam-splitting assembly 3 and a beam converging assembly 4. The beam collimation assembly 2 is used for collimating the incident light 1; after passing through the beam collimation assembly 2, the incident light 1 propagates in space in an approximately parallel state, and the beam collimation assembly 2 may adopt an existing lens group. The collimated incident light 1 enters the polarization beam-splitting assembly 3, which adjusts the polarization characteristics of the incident light 1, so that each part of light in the incident light 1 generates the required polarization state, respectively, and the polarization beam-splitting assembly 3 comprises polarization selective elements such as polarizers. The incident light 1 with adjusted polarization characteristics enters the beam converging assembly 4, which converges the incident light 1 and injects it into the nonlocal dispersion device 5 in a specific spatial light distribution. The beam converging assembly 4 includes optical elements with strong beam convergence capability such as microscope objectives, lenses, microlenses, microlens arrays or super-lenses.

The nonlocal dispersion device 5 is used for modulating the incident spatial light field, and its function is to generate a specific transmission intensity distribution for different polarization states and different incident spectra. The intensity Iₜ(ψ, λ, θ, φ, η) at any point in the transmission intensity distribution generated by the nonlocal dispersion device 5 satisfies the following formula:

Iₜ(ψ,λ,θ,φ,η)=A²·(Tₚ(θ,λ)·B(P,φ,η)+Tₛ(θ,λ)·C(P,φ,η))
wherein A denotes the amplitude of the spatial light field; Tₚ (θ, λ) denotes the transmittance spectrum of the nonlocal dispersion device for p-polarized light at an incident angle θ;
Tₛ(θ, λ) denotes a transmittance spectrum of the nonlocal dispersion device for s-polarized light at an incident angle θ;
P(ψ,δ) denotes a polarization state of light with an electric field Eᵢ=A[cos ψ sin ψe^{iδ}]^{T}, wherein ψ denotes the amplitude angle of polarized light, and (tan ψ=E_{yo}/Eₓₒ), δ denotes a phase difference between electric fields in x direction and y direction, and (δ=δ_{y}−δₓ), φ denotes an azimuth angle at any point in the transmission intensity distribution, and η denotes a phase retardation between p component and s component in the nonlocal dispersion device;
   B(P,φ,η) and C(P,φ,η) are constant coefficients related to P, φ and η, wherein

$$B ( P , φ , η ) = {cos}^{2} {ψcos}^{2} φ + {sin}^{2} {ψsin}^{2} φ + \frac{1}{2} sin 2 ψsin2φcos ( δ + η )$$

$$C ( P , φ , η ) = {sin}^{2} {ψcos}^{2} φ + {cos}^{2} {ψsin}^{2} φ - \frac{1}{2} sin 2 ψsin2φ cos ( δ + η ) .$$

In addition, in order to obtain higher detection accuracy of high dimensional information, it is necessary to first design the nonlocal dispersion device 5 by means of simulation calculation, particle swarm optimization and other methods, so that multiple resonance peaks in the reflectance spectrum of the nonlocal dispersion device 5 are uniformly distributed in the required wavelength range, and then substitute the characteristic parameters of the designed nonlocal dispersion device 5 into the above formula to finally obtain the transmission intensity distribution in k-space.

The nonlocal dispersion device 5 is designed using materials such as dielectrics, metals, semiconductor materials, ferromagnetic materials and two dimensional materials according to its operating wavelength range. The structural form of the nonlocal dispersion device 5 may mainly adopt interface, single-layer thin-film structure, multi-layer thin-film structure, metasurface, photonic crystal, two-dimensional material heterojunction device, or porous scattering medium. As shown in FIG. 2, the nonlocal dispersion device 5 operating in the 400-900 nm wide wavelength range adopted in the embodiment of the present disclosure adopts a multi layer thin film structure, which is specifically comprises eight transparent thin films with different thicknesses, sequentially: titanium dioxide film 5-1, silicon dioxide film 5-2, titanium dioxide film 5-1, single crystal quartz film 5-3, magnesium fluoride crystal film 5-4, titanium dioxide film 5-1, silicon dioxide film 5-2 and titanium dioxide film 5-1. In addition, by changing the design of the nonlocal dispersion device 5, it can be used to realize detection and imaging of wide spectrum polarization spectral high dimensional information in any operating wavelength range.

After passing through the nonlocal dispersion device 5, the incident light 1 forms a specific transmission intensity distribution; the optical receiving device 6 is used for receiving the transmission intensity distribution in a form of an image. The optical receiving device 6 adopts an optical camera, which can image in the operating wavelength range to obtain a transmission intensity distribution image. The information analysis device 7 receives the transmission intensity distribution image, analyzes the transmission intensity distribution, and then outputs high dimensional intensity, polarization and spectral information of the incident light 1. The information analysis device 7 comprises a computer pre-installed with trained neural network image analysis algorithms such as convolutional neural networks, residual networks and recurrent neural networks, and can automatically output high dimensional intensity, polarization, spectrum and other information of the incident light 1 through the received transmission intensity distribution information.

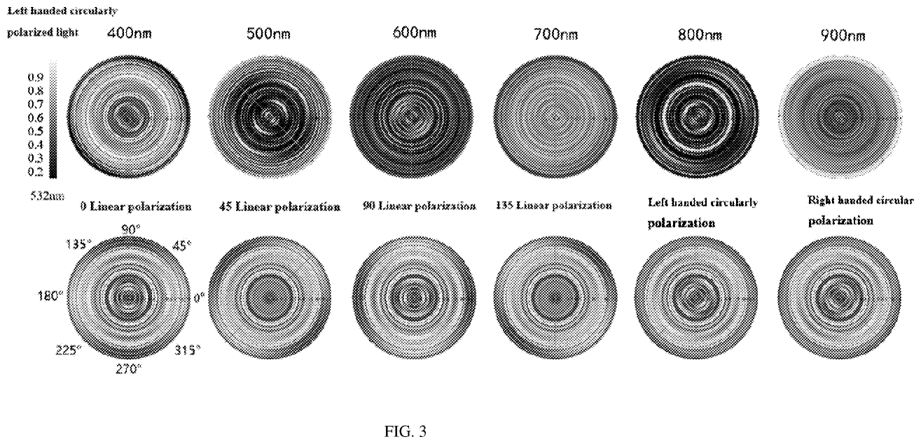

As shown in FIG. 3, the nonlocal dispersion device 5 operating in the 400-900 nm wide wavelength range adopted in the embodiment of the present disclosure obtains a transmission intensity distribution image in k-space. In the upper row of FIG. 3, transmission intensity distribution images are shown when the polarization state of the incident light 1 is fixed as left handed circular polarization and remains unchanged, and the wavelengths of the incident light 1 are 400 nm, 500 nm, 600 nm, 700 nm, 800 nm and 900 nm, respectively; in the lower row of FIG. 3, transmission intensity distribution images are shown when the wavelength of the incident light 1 is fixed at 532 nm and the polarization states of the incident light 1 are 0° linear polarization, 45° linear polarization, 90° linear polarization, 135° linear polarization, left handed circular polarization and right handed circular polarization, respectively.

Compared with the traditional polarization spectral multiplexing detection system combining multiple polarization detectors and spectrometers, the present disclosure has a more compact structure, can image without using a spectrometer, and does not require the combination of multiple polarization detectors, greatly improving the integration and miniaturization of the system. Moreover, the present disclosure only requires a single measurement by a single detector during operation, which greatly reduces the system complexity and measurement time cost. At the same time, the present disclosure can also realize imaging and information extraction of high dimensional complex incident light fields whose polarization states vary with wavelength, which is difficult to achieve by existing systems. On the premise of ensuring the ability to extract high dimensional polarization spectral information, the present disclosure opens a new door for the further miniaturization of polarization spectral photodetectors.

Although the embodiments of the present disclosure have been shown and described above, it should be understood that the above embodiments are exemplary and should not be construed as limiting the present disclosure. Those of ordinary skill in the art can make changes, modifications, substitutions and variations to the above embodiments within the scope of the present disclosure.

The above specific embodiments of the present disclosure do not limit the protection scope of the present disclosure. Any other corresponding changes and modifications made according to the technical concept of the present disclosure shall be included in the protection scope of the claims of the present disclosure.

1. A dispersion-based nonlocal polarization-spectral high-dimensional photodetector, comprising:
a spatial light modulation device, a nonlocal dispersion device, an optical receiving device, and an information analysis device;
wherein an incident light is modulated by the spatial light modulation device to form a spatial light field, a polarization state and a spectra of light in the spatial light field are different, the spatial light field irradiating the nonlocal dispersion device generates a corresponding transmission intensity distribution; the optical receiving module receives and images the transmission intensity distribution, and the information analysis module analyzes the transmission intensity distribution and outputs high-dimensional intensity, polarization, and spectral information of the incident light.

2. The dispersion-based nonlocal polarization-spectral high-dimensional photodetector according to claim 1, wherein
the spatial light modulation device comprises a beam collimation assembly, a polarization beam-splitting assembly, and a beam converging assembly; wherein the beam collimation assembly is configured to collimate the incident light; the polarization beam-splitting assembly is configured to change the polarization state of the incident light; and the beam converging assembly is configured to converge the incident light.

3. The dispersion-based nonlocal polarization-spectral high-dimensional photodetector according to claim 1, wherein
the nonlocal dispersion device adopt an interface, a single-layer thin-film structure, a multi-layer thin-film structure, a metasurface, a photonic crystal, a two-dimensional material heterojunction device, or a porous scattering medium.

4. The dispersion-based nonlocal polarization-spectral high-dimensional photodetector according to claim 1, wherein
an intensity Iₜ(ψ, λ, θ, φ, η) at any point in the transmission intensity distribution generated by the nonlocal dispersion device satisfies following formula:
Iₜ(ψ,λ,θ,φ,η)=A²·(Tₚ(θ,λ)·B(P,φ,η)+Tₛ(θ,λ)·C(P,φ,η))
wherein A denotes the amplitude of the spatial light field; Tₚ (θ, λ) denotes the transmittance spectrum of the nonlocal dispersion device for p-polarized light at an incident angle θ;
Tₛ(θ, λ) denotes a transmittance spectrum of the nonlocal dispersion device for s-polarized light at an incident angle θ;
P(ψ,δ) denotes a polarization state of light with an electric field Eᵢ=A[cos ψ sin ψe^{iδ}]^{T}, P denotes a polarization state of the electric field, ψ denotes an amplitude angle of polarized light, δ denotes a phase difference between electric fields in x direction and y direction, φ denotes an azimuth angle at any point in the transmission intensity distribution, and η denotes a phase retardation between p component and s component in the nonlocal dispersion device;
B(P,φ,η) and C(P,φ,η) are both constant coefficients.

5. The dispersion-based nonlocal polarization-spectral high-dimensional photodetector according to claim 3, wherein
the nonlocal dispersion device comprises eight layers of transparent thin films, which are sequentially: titanium dioxide film, silicon dioxide film, titanium dioxide film, single-crystal quartz film, magnesium fluoride crystal film, titanium dioxide film, silicon dioxide film, and titanium dioxide film.

6. The dispersion-based nonlocal polarization-spectral high-dimensional photodetector according to claim 1, wherein
the optical receiving device adopts an optical camera for receiving the transmission intensity distribution.

7. The dispersion-based nonlocal polarization-spectral high-dimensional photodetector according to claim 1, wherein
the information analysis device analyzes the transmission intensity distribution via residual neural network.
